(19) United States
(12) Patent Application Publication
(10) Pub. No.: US 2017/0374460 A1
(43) Pub. Date: Dec. 28, 2017

(54) APPARATUS AND METHOD OF PROCESSING SOUND FROM ENGINE, VEHICLE, AND METHOD OF CONTROLLING THE VEHICLE

(71) Applicant: Hyundai Motor Company, Seoul (KR)

(72) Inventors: In Soo JUNG, Suwon-si (KR); Jaemin JIN, Seoul (KR); Dongchul LEE, Anyang-si (KR)

(73) Assignee: Hyundai Motor Company, Seoul (KR)

(21) Appl. No.: 15/337,730

(22) Filed: Oct. 28, 2016

(30) Foreign Application Priority Data
Jun. 23, 2016 (KR) 10-2016-0078753

(51) Int. Cl. H04R 3/04

(52) U.S. Cl. CPC H04R 3/04; H04R 2430/03; H04R 2499/13

(57) ABSTRACT

The present disclosure provides apparatuses and methods of processing a sound from an engine or a vehicle. The apparatus for processing a sound from the engine includes: an engine to generate an engine sound; a sensing device to sense vibration of the engine; a controller to generate a reinforcing signal to reinforce a region of the engine sound based on the vibration and an output unit to output a reinforcing sound corresponding to the reinforcing signal.

### CROSS-REFERENCE TO RELATED APPLICATION

This application claims priority to and the benefit of Korean Patent Application No. 10-2016-0078753, filed on Jun. 23, 2016, which is incorporated herein by reference by in its entirety.

### FIELD

The present disclosure relate to apparatuses and methods of processing a sound from an engine, a vehicle, and a method of controlling the vehicle.

### BACKGROUND

The statements in this section merely provide background information related to the present disclosure and may not constitute prior art.

Vehicles are machines that transport people or cargo to a destination while travelling on roads or railways. A vehicle may transport people, or the like while moving in a predetermined direction using at least one wheel mounted on a body of the vehicle. Examples of the vehicle may include three-wheeled or four-wheeled automobiles, two-wheelers such as motorcycles, construction machines, bicycles, and trains running on railways.

A vehicle includes an engine to supply mechanical energy desired to drive the vehicle. The engine converts thermal energy obtained by burning fossil fuels such as gasoline or diesel into mechanical energy. For example, when a mixed gas of air and a fuel is supplied into a combustion chamber of the engine, the mixed gas is compressed by operation of a piston and exploded by a spark generated by an ignition plug, and the piston lowered by the explosion of the mixed gas converts thermal energy into mechanical energy. While the thermal energy is converted into mechanical energy in the engine, a vibration is generated by the operation of the engine and an engine sound is generated thereby.

### SUMMARY

The present disclosure provides apparatuses and methods of processing a sound from an engine, a vehicle, and a method of controlling the vehicle to obtain a desired engine sound by tuning the sound generated in the engine.

It is another aspect of the present disclosure to provide apparatuses and methods of processing a sound from an engine, a vehicle, and a method of controlling the vehicle to provide a driver of the vehicle and/or a passenger with various engine sounds in accordance with tastes of the driver and/or the passenger.

Additional aspects of the disclosure will be set forth in part in the description which follows and, in part, will be obvious from the description, or may be learned by practice of the disclosure.

In order to solve the technical problem described above, apparatuses and methods of processing a sound from an engine, a vehicle, and a method of controlling the vehicle are provided.

According to an aspect of an exemplary form, there is provided an apparatus for processing a sound from an engine comprising an engine configured to generate an engine sound, a sensing device configured to sense vibration of the engine, a controller configured to generate a reinforcing signal to reinforce a region of the engine sound based on the vibration and an output unit configured to output a reinforcing sound corresponding to the reinforcing signal.

The output unit may be installed in a space in which the engine is installed.

The controller may generate a reinforcing signal to reinforce a vibration in a pre-defined frequency band.

The controller may generate a reinforcing signal to reinforce all regions or a partial region of at least one order component among a plurality of order components of the engine.

The controller may generate a reinforcing signal to reinforce a region with a relatively high intensity or a region with a relatively low intensity among all regions of the order component.

The controller may generate a reinforcing signal to reinforce all regions or a partial region of at least one order component by using preset weights.

The weights may be different according to the at least one order component.

The controller may generate different reinforcing signals to reinforce all regions or a partial region of the at least one order component among the plurality of order components of the engine in accordance with a driving mode of a vehicle.

The controller may generate a reinforcing signal to reinforce a portion of the vibration in real time.

According to an aspect of an exemplary form, there is provided a vehicle comprising an engine room separated from an indoor space of the vehicle, an engine installed in the engine room, a sensing device installed in contact with or adjacent to the engine and configured to sense vibration of the engine, a controller configured to generate a reinforcing signal to reinforce a portion of the vibration based on the vibration and an output unit installed in the engine room and configured to generate a reinforcing sound based on the reinforcing signal and output the reinforcing sound toward the indoor space.

According to an aspect of an exemplary form, there is provided a method of processing a sound from an engine, the method comprising sensing a vibration of an engine, generating a reinforcing signal to reinforce a portion of the vibration based on the vibration and outputting a reinforcing sound corresponding to the reinforcing signal by an output unit.

The output unit may be installed in the same space as a space in which the engine is installed.

The generating of the reinforcing signal to reinforce a portion of the vibration based on the vibration may comprise generating a reinforcing signal to reinforce a vibration in a predefined frequency band.

The generating of the reinforcing signal to reinforce a portion of the vibration based on the vibration may comprise generating a reinforcing signal to reinforce all regions or a partial region of at least one order component among a plurality of order components of the engine.

The generating of the reinforcing signal to reinforce all regions or a partial region of at least one order component among the plurality of order components of the engine may comprise generating a reinforcing signal to reinforce a region with a relatively high intensity or a region with a relatively low intensity among all regions of the order component.

The generating of the reinforcing signal to reinforce all regions or a partial region of at least one order component among the plurality of order components of the engine may comprise generating a reinforcing signal to reinforce all regions or a partial region of the at least one order component by using preset weights.

The weights may be different according to the at least one order component.

The generating of the reinforcing signal to reinforce all regions or a partial region of at least one order component among the plurality of order components of the engine may comprise generating different reinforcing signals to reinforce all regions or a partial region of at least one order component among the plurality of order components of the engine in accordance with a driving mode of the vehicle.

The generating of the reinforcing signal to reinforce a portion of the vibration based on the vibration may be performed in real time.

According to an aspect of an exemplary form, there is provided

a method of controlling a vehicle, the method comprising sensing a vibration of an engine installed in an engine room separated from an indoor space of the vehicle, generating a reinforcing signal to reinforce a portion of the vibration based on the vibration and generating a reinforcing sound based on the reinforcing signal and outputting the reinforcing sound toward the indoor space by an output unit installed in the engine room.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating an inner structure of a vehicle;

FIG. 2 is a block diagram illustrating an apparatus for processing a sound from an engine;

FIG. 3 is a graph illustrating an example of vibration of an engine;

FIG. 4 is a block diagram illustrating a controller;

FIG. 5 is a first diagram for describing order components of an engine sound;

FIG. 6 is a second diagram for describing order components of the engine sound;

FIG. 7 is a graph illustrating a first example of weights applied to an order component of the engine;

FIG. 8 is a graph illustrating a second example of weights applied to an order component of the engine;

FIG. 9 is a graph illustrating a third example of weights applied to an order component of the engine;

FIG. 10 is a first diagram for describing order components of an engine sound reinforced by the controller;

FIG. 11 is a second diagram for describing order components of the engine sound reinforced by the controller; and

FIG. 12 is a flowchart for describing a method of processing an engine sound according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

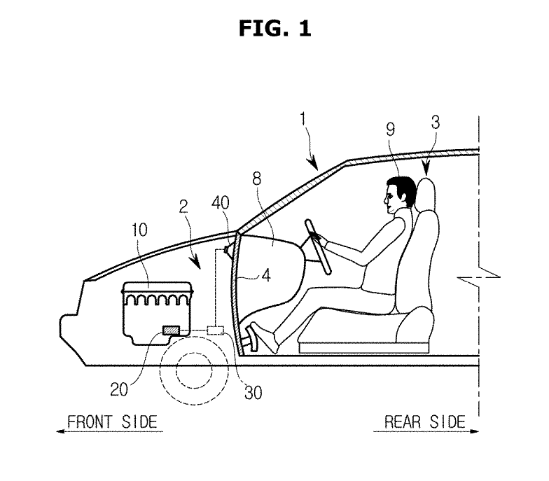

An apparatus for processing a sound from an engine and a vehicle according to the present disclosure will be described with reference to FIGS. 1 to 11.

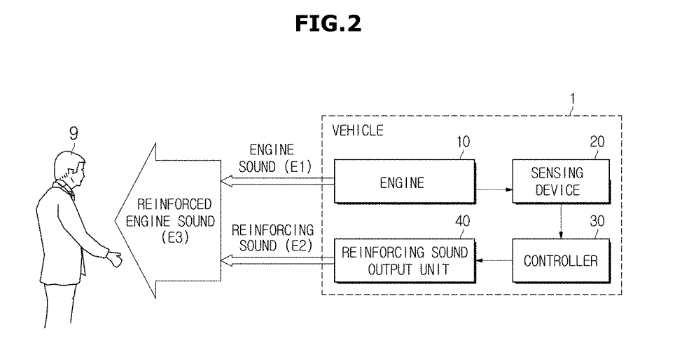

FIG. 1 is a view illustrating an inner structure of a vehicle. FIG. 2 is a block diagram illustrating an apparatus for processing a sound from an engine. A direction in which the vehicle 1 generally proceeds is referred to a front side, and an opposite direction thereto is referred to as a rear side in FIG. 1.

Referring to FIG. 1, a vehicle 1 includes an engine room 2 in which an engine 10 is installed and an indoor space 3 where a driver and/or a passenger (hereinafter, referred to as a user 9) sits. According to one form, the engine room 2 may be located in front of the indoor space 3 or behind the indoor space 3. A bulkhead 4 for space division into the engine room 2 and the indoor space 3 may be installed between the engine room 2 and the indoor space 3. The bulkhead 4 may be a part of a frame of a body or a separate part from the frame. The engine room 2 and the indoor space 3 may also be separated from each other by a dashboard as well as the bulkhead 4. The dashboard may be mounted with an instrument cluster (not shown), various multimedia devices for vehicle, vents of an air conditioner, a speaker to output sounds, and various input devices to control the vehicle. In this regard, the speaker may output sounds reproduced by the multimedia devices for vehicle into the indoor space 3.

Referring to FIGS. 1 and 2, the vehicle 1 may include an engine 10, a sensing device 20 configured to sense operation of the engine 10, a controller 30 configured to process a signal output from the sensing device 20, and a reinforcing sound output unit 40 configured to provide the user 9 with a signal in response to a result processed by the controller 30.

The engine 10 is installed inside the engine room 2 and obtains mechanical energy desired to drive the vehicle 1 via combustion of fossil fuels such as gasoline or diesel. The engine 10 may be a four cycle engine. In this case, the engine 10 obtains power of the vehicle 1 via an intake cycle, a compression cycle, an explosion/expansion cycle, and an exhaust cycle.

The engine 10 may include one or at least two cylinders. A plurality of cylinders may be arranged in serious, in a V shape, or in parallel. When the engine 10 is a four cycle engine, the cylinder may be provided with various parts such as an intake pipe into which a mixed gas of air and a fuel is drawn in, a combustion chamber in which the mixed gas explodes and expands, an intake valve opened or closed to form or close an air path between the intake pipe and the combustion chamber, an ignition plug to induce explosion of the mixed gas contained in the combustion chamber, a piston to reciprocate within the combustion chamber to induce intake of the mixed gas and compress the mixed gas, and an exhaust valve to discharge the expanding mixed gas in the form of exhaust fumes. While the four cycles are performed in the engine 10, the piston is raised or lowered. In response to the raising and lowering operation of the piston, a crankshaft mechanically connected to the piston rotates. Rotation of the crankshaft is transferred to wheels of the vehicle 1, and the wheels rotate in accordance with the rotation of the crankshaft. Accordingly, the vehicle 1 may move forward or backward. The crankshaft continuously rotates in accordance with repeated cycles while the vehicle 1 operates. Hereinafter, revolutions per minute (RPM) of the crankshaft is referred to as engine RPM. The engine RPM may frequently vary, i.e., increase or decrease, in accordance with a driving state of the vehicle 1. The engine RPM is influenced by various factors such as a current state of the vehicle 1 such as a stop or moving state of the vehicle 1, a velocity of the vehicle 1, a gear level, an amount of sprayed fuel, or the like.

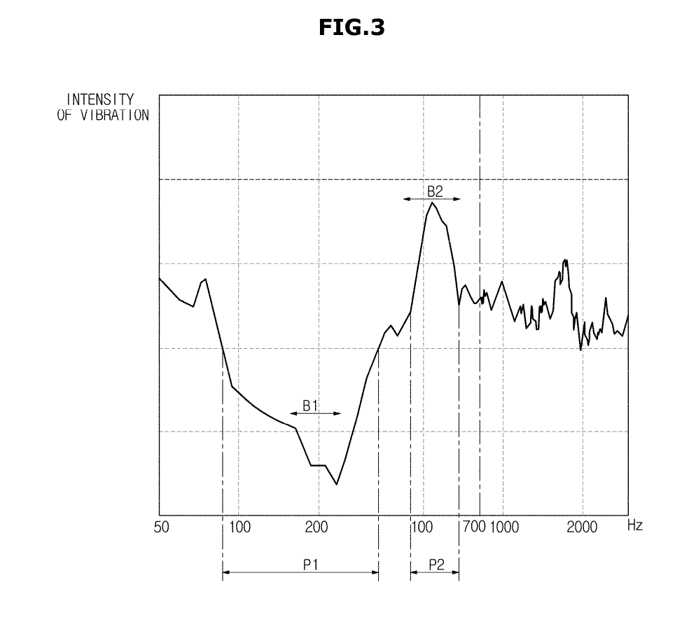

FIG. 3 is a graph illustrating an example of vibration of an engine. FIG. 3 illustrates vibration of the engine with respect to frequency domains. X-axis indicates vibration frequency of the engine, and Y-axis indicates intensity of vibration.

When operation of the engine 10 is started in accordance with a driver's manipulation, the explosion/expansion cycle, and the like performed in the combustion chamber of the engine 10 cause vibration of the engine 10. In this case, the engine 10 vibrates with a variety of intensities and frequencies in accordance with various factors such as the engine RPM, the velocity of the vehicle 1, the amount of sprayed fuel, and the gear level as illustrated in FIG. 3. For example, as the engine RPM increases, the vibration frequency may increase. While the engine 10 operates, an intensity of vibration in one given frequency band p1 may be relatively lower than those of vibration in the other frequency bands, and an intensity of vibration in another given frequency band p2 may be relatively higher than those of vibration in the other frequency bands.

Meanwhile, an engine sound (booming noise, E1) is generated in the engine 10 by explosion occurring inside the combustion chamber and vibration of the engine 10. An intensity of the engine sound E1 may correspond to the intensity of vibration of the engine 10. As described above, the engine 10 may vibrate with a variety of intensities and frequencies in accordance with the various factors. Depending on the intensity of vibration and/or vibration frequency of the engine 10, the engine sound E1 may be generated to have various volumes and patterns. In this case, the frequency of the engine sound E1 corresponds to the vibration frequency of the engine 10.

The sensing device 20 may sense operation of the engine 10 and transmit a sensing result to the controller 30. According to one form, the sensing device 20 is provided to sense at least one of vibration caused by the operation of the engine 10 and a vibration sound caused by the vibration (hereinafter, referred to as vibration).

According to one form, the sensing device 20 may include at least one vibration sensor. The vibration sensor may include at least one of a piezoelectric vibration sensor and a moving-coil type vibration sensor. Besides, various other devices to sense vibration or vibration sound may be used as the vibration sensor.

The sensing device 20 may be installed in the engine room 2. According to one form, the sensing device 20 may be disposed to be in direct contact with the engine 10 to sense vibration of the engine 10 or vibration sound caused by the vibration of the engine 10. According to another form, the sensing device 20 is disposed to be adjacent to and spaced apart from the engine 10 to sense vibration of the engine 10. The sensing device 20 may be disposed at a side surface of the engine 10 or at a top or bottom surface of the engine 10. Besides, the sensing device 20 may also be installed at various positions to sense vibration of the engine 10. In addition, if the sensing device 20 is implemented using a sensor, the sensing device 20 may include a plurality of sensors. All the sensors may be in direct contact with the engine 10 or spaced apart from the engine 10. Alternatively, some sensors may be in direct contact with the engine 10, and the other sensors may be spaced apart from the engine 10.

The sensing device 20 may output an electric signal corresponding to vibration in accordance with the vibration of the engine 10, and the output electric signal is transmitted to the controller 30.

The controller 30 may receive the sensing result about vibration of the engine 10 from the sensing device 20 as an electric signal and generate an electric signal, i.e., reinforcing signal, to allow the reinforcing sound output unit 40 to output a reinforcing sound E2, which is a sound to reinforce all of or a part of the engine sound E1, based on the received sensing result, i.e., vibration of the engine 10 sensed by the sensing device 20.

Particularly, for example, the controller 30 may determine whether all of or a part of the engine sound E1 needs to be reinforced based on the sensing result of the sensing device 20 and generate a reinforcing signal for a region to be reinforced using predefined settings. In this case, the controller 30 may generate a reinforcing signal to reinforce the engine sound E1 generated by vibration in the frequency band p1 having a relatively low intensity of vibration. Or, on the contrary, the controller 30 may generate a reinforcing signal to reinforce the engine sound E1 generated by vibration in the frequency band p2 having a relatively high intensity of vibration.

According to one form, the controller 30 may generate the reinforcing signal by order analysis. In addition, if there is no region to be reinforced in the engine sound E1, the controller 30 may not generate the reinforcing signal. In this case, the reinforcing signal is not transmitted to the reinforcing sound output unit 40. Accordingly, the reinforcing sound output unit 40 does not output the reinforcing sound. Operation of the controller 30 to generate the reinforcing signal will be described in more detail later.

The controller 30 may transmit the generated reinforcing signal to the reinforcing sound output unit 40. In this case, the controller 30 may generate the reinforcing signal and transmit the reinforcing signal to the reinforcing sound output unit 40 in real time. In another form, the controller 30 may generate the reinforcing signal, and transmit the reinforcing signal to the reinforcing sound output unit 40 at an appropriate time in need.

The controller 30 may be implemented using one or at least two processors, and the processors may be implemented using one or at least two semiconductor chips and related parts. The processors to realize the controller 30 may be disposed inside the engine room 2 as illustrated in FIG. 2 or inside the indoor space 3 of the vehicle 1. In addition, the one or at least two processors may be an electronic control unit (ECU) installed in the vehicle 1 in advance, a processor of a multimedia device for vehicle such as a navigation device, or a processor manufactured separately therefrom and programmed.

According to one form, the controller 30 may be implemented using one or at least two processors installed inside the vehicle 1, or a separate computer device spaced apart from the vehicle 1. Examples of the computer device spaced apart from the vehicle 1 may include navigation devices, mobile phones, smart phones, tablet PCs, laptop computers, desktop computers, servers, or other electronic devices.

The reinforcing sound output unit 40 receives the reinforcing signal from the controller 30, generates a reinforcing sound E2 corresponding to the received reinforcing signal, and outputs the generated reinforcing sound E2. The reinforcing sound E2 output from the reinforcing sound output unit 40 is mixed together with the engine sound E1 from the engine 10, and a reinforced engine sound E3 generated as a result of mixing the engine sound E1 and the reinforcing sound E2 is output toward the indoor space 3 of the vehicle 1. Thus, the user 9 may listen the reinforced engine sound E3 which may improve interest and joy of driving the vehicle 1 and feels acceleration of the vehicle 1 as sounds. If the reinforcing sound output unit 40 does not output the reinforcing sound E2, the user 9 may listen only the engine sound E1 generated in the engine 10.

According to another form, the reinforcing sound output unit 40 may be implemented using various speakers. The speaker may be implemented using at least one of various types of speakers such as a moving-coil type speaker, an electromagnetic speaker, an electrostatic loudspeaker, a dielectric speaker, and a magnetic warping speaker. In addition, the speaker may also be implemented using at least one selected from a radiation type speaker and a horn type speaker.

In one form, the reinforcing sound output unit 40 may be installed at one position inside the engine room 2 as illustrated in FIG. 2. More particularly, the reinforcing sound output unit 40 may be installed at the bulkhead 4 or around the bulkhead 4 that separates the engine room 2 from the indoor space 3 such that the reinforcing sound E2 is output toward the indoor space 3. In this case, the reinforcing sound output unit 40 may be mounted directly on the bulkhead 4 or spaced apart from the bulkhead 4 at a predetermined distance. If the reinforcing sound output unit 40 is implemented using a speaker, the reinforcing sound output unit 40 may be installed at the bulkhead 4 such that the speaker faces the bulkhead 4. The reinforcing sound E2 output from the reinforcing sound output unit 40 is transmitted to the indoor space 3 of the vehicle 1 via the bulkhead 4.

One or at least two reinforcing sound output units 40 may be installed at the bulkhead 4 by a designer, if desired. For example, the reinforcing sound output unit 40 may be installed at an upper portion of the bulkhead 4 as illustrated in FIG. 1. The upper portion of the bulkhead 4 may include a portion of the bulkhead 4 disposed between the dashboard and the engine room 2. Also, the reinforcing sound output unit 40 may be installed at a lower portion of the bulkhead 4. In addition, the reinforcing sound output unit 40 may be mounted directly on one surface of the dashboard facing the engine room 2. Besides, the reinforcing sound output unit 40 may be installed at various positions selected by the designer to appropriately transmit the reinforced engine sound E3 to the indoor space 3.

According to another form, the reinforcing sound output unit 40 may be installed in the indoor space 3 of the vehicle 1. In this case, the reinforcing sound output unit 40 may be implemented using a speaker separately manufactured to be installed in the indoor space 3. Also, the reinforcing sound output unit 40 may be implemented using various sound output devices provided in the indoor space 3 of the vehicle 1. For example, the reinforcing sound output unit 40 may be implemented using one or at least two speakers for vehicle installed in the indoor space 3 of the vehicle 1 or using a speaker of a multimedia device for vehicle such as a navigation device (not shown) installed in the vehicle 1. Besides, any other sound output devices installed in the vehicle 1 selected by the designer may be used as the reinforcing sound output unit 40.

The sensing device 20, the controller 30, and the reinforcing sound output unit 40 may communicate with one another by using at least one of a wired communication network and a wireless communication network and may transmit and receive various data such as the electric signal and the reinforcing signal corresponding to vibration. In this regard, the wired communication network may include a variety of cables such as fair cable, coaxial cable, optical fiber cable, or Ethernet cable. In addition, the wireless communication network may be implemented using at least one of local-area communication technology and mobile communication technology. The local-area communication technology may be implemented using at least one of Controller Area Network (CAN), Wireless LAN, Wi-Fi, Wi-Fi Direct, Zigbee, ultra-wideband, Infrared Data Association (IrDA), Bluetooth, Bluetooth Low Energy, and Near Field Communication (NFC). The mobile communication technology may be implemented based on at least one wireless communication technology implemented using various mobile communication standards such as 3GPP, 3GPP2 or WiMAX. The sensing device 20, the controller 30, and the reinforcing sound output unit 40 may respectively include various parts, e.g., a connection port or a wireless communication chip, respectively to use the wired communication network or the wireless communication network.

Hereinafter, examples of generating the reinforcing signal and the reinforcing sound E2 in accordance with operation of the controller 30 will be described in more detail.

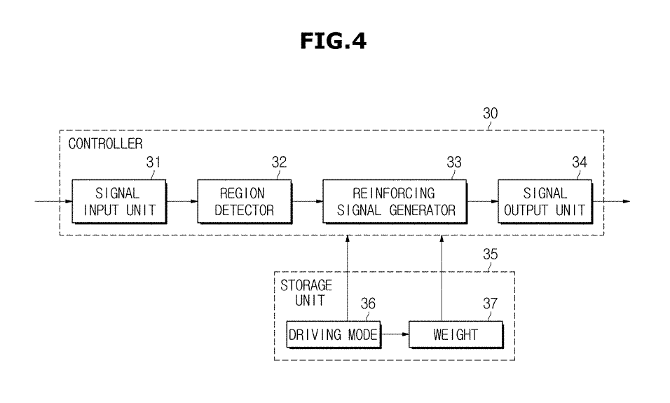

FIG. 4 is a block diagram illustrating a controller according to one form of the present disclosure.

Referring to FIG. 4, the controller 30 may include a signal input unit 31, a region detector 32, a reinforcing signal generator 33, and a signal output unit 34. Here, the signal input unit 31, the region detector 32, the reinforcing signal generator 33, and the signal output unit 34 may be physically separated and/or logically separated from one another. Although the region detector 32 is separated from the reinforcing signal generator 33 in FIG. 4, the region detector 32 and the reinforcing signal generator 33 may be implemented by using one processor.

The signal input unit 31 receives a sensing result of vibration of the engine 10 from the sensing device 20. For example, the signal input unit 31 may receive information about vibration of the engine 10 as illustrated in FIG. 3 as an electric signal from the sensing device 20.

The region detector 32 may detect a target portion or region of the engine sound E1 for reinforcement (hereinafter, referred to as a reinforcement region) based on the sensing result of vibration of the engine 10. According to one form, the region detector 32 may detect the reinforcement region of the engine sound E1 from vibration of all frequency bands.

According to another form, the region detector 32 may detect a reinforcement region of the engine sound E1 based on vibration of a predefined range of frequency bands. For example, the region detector 32 may detect the reinforcement region from vibration of a predetermined frequency or less, or vibration of a predetermined frequency or greater. More particularly, for example, the region detector 32 may detect the reinforcement region from vibration with a frequency of approximately 700 Hz or less and may not detect the reinforcement region from vibration with a frequency greater than approximately 700 Hz as illustrated in FIG. 3.

Also, the region detector 32 may detect a target region of the engine sound E1 for reinforcement based on a current driving mode 36 of the vehicle 1. The vehicle 1 may run in various driving modes 36, and the driving modes 36 may be manually set by a user's manipulation or automatically set according to predefined settings. The set driving mode 36 may be stored in a storage unit 35. In this regard, the storage unit 35 may be separately provided from the controller 30 and may be implemented using various devices designed by the designer such as semiconductor storage devices, magnetic disc storage devices, or magnetic drum storage devices. The region detector 32 may call a driving mode 36 stored in the storage unit 35 and detect a region to be reinforced in the engine sound E1 in accordance with the called driving mode 36. For example, when the driving mode 36 of the vehicle 1 is set as a sport mode, a reinforcement region may be detected such that the user listens a reinforced engine sound E3 in accordance with sporty driving. More particularly, for example, the reinforcement region may be detected to reinforce the engine sound E1 in a frequency band corresponding to a high engine RPM.

The region detector 32 may detect a given region to remove a noise inside the vehicle 1. For example, when a noise of a powertrain is generated, the region detector 32 may determine a frequency band corresponding to the noise of the powertrain as the reinforcement region. The reinforcing signal generator 33, which will be described later, may generate a reinforcing signal to allow the reinforcing sound output unit 40 to output a sound to mask the noise.

According to one form, the region detector 32 may detect the reinforcement region in the engine sound E1 by order analysis.

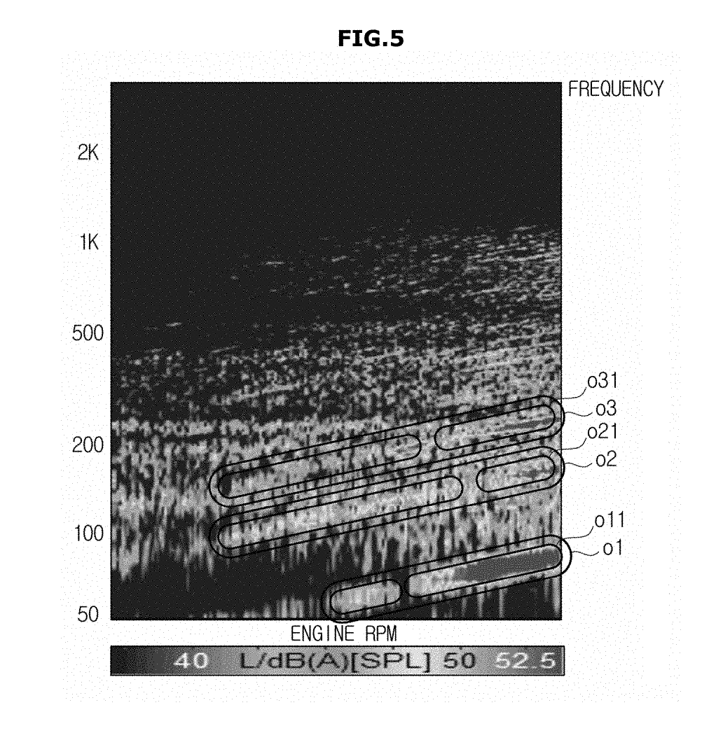

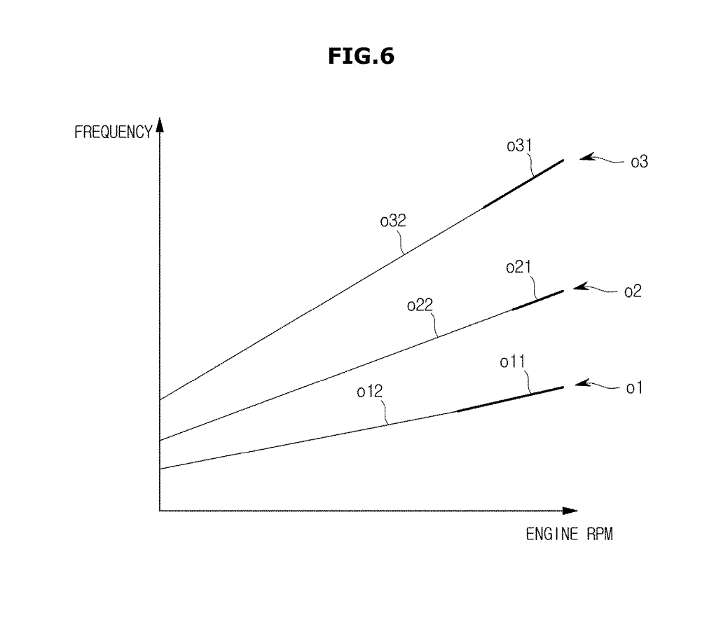

FIG. 5 is a first diagram for describing order components of an engine sound. FIG. 6 is a second diagram for describing order components of the engine sound. FIG. 6 is a simplified diagram of FIG. 5. In FIGS. 5 and 6, X-axis indicates engine RPM, and Y-axis indicates frequency of engine sound. Unless otherwise stated, Herz (Hz) is used as a unit of frequency and RPM is used as a unit of the engine RPM in the graphs.

In FIG. 5, a red part indicates a higher intensity of the engine sound, and a blue part indicates a lower intensity of the engine sound. A green part indicates a moderate intensity of the engine sound. In FIG. 6, a bold line indicates a relatively high intensity of the engine sound, and a fine line indicates a relatively low intensity of the engine sound. In addition, in FIGS. 5 and 6, O1 indicates a second order component (hereinafter, referred to as C2 component), and O2 indicates a fourth order component (hereinafter, referred to as C4 component). O3 indicates a sixth order component (hereinafter, referred to as C6 component).

During driving of the vehicle 1, the engine RPM may continuously change, and the vibration frequency of the engine 10 may also continuously change in response to the engine RPM (B1 and B2 of FIG. 3). Thus, the controller 30 may detect a region to be reinforced in the engine sound E1 by using a noise component (hereinafter, referred to order component) proportional to the engine RPM and generate a reinforcing signal in accordance therewith corresponding to the change in the frequency. In this case, an order of the order component is a cause of the noise generated per unit rotation. For example, the order of the order component caused by two noise causes per unit rotation is 2, and the order of the order component caused by four noise causes per unit rotation is 4. In more particular, for example, if the engine 10 includes four cylinders, the engine sound E1 may be caused by the explosion and expansion cycle performed in the combustion chamber. Since two explosions are obtained during every rotation of the crankshaft, four explosions may be obtained in total by two rotations of the crankshaft in the engine 10. Thus, an order of the order component in accordance with the rotation of the engine is 2.

When the engine sound E1 is generated in accordance with operation of the engine 10, the engine sound E1 may include one or at least two order components O1, O2, and O3 as illustrated in FIGS. 5 and 6. For example, the engine sound E1 may include three order components, i.e., a C2 component, a C4 component, and a C6 component. In this case, each component may have regions with relatively higher intensities (O11, O21, and O31) and regions with relatively lower intensities (O12, O22, and O32).

The region detector 32 of the controller 30 may detect a region to be reinforced from one or at least two order components O1, O2, and O3 of the engine sound E1 by using vibration of the engine 10 sensed by the sensing device 10. As described above, since the vibration frequency of the engine 10 corresponds to the frequency of the engine sound E1, the region detector 32 may detect a region to be reinforced in the engine sound E1 by using information about vibration of the engine 10.

More particularly, the region detector 32 may detect at least one of the order components O1, O2, and O3 based on information about vibration of the engine 10 sensed by the sensing device 20 and information about the engine RPM received from an engine RPM measuring device. In this case, the region detector 32 may detect at least one of the order components O1, O2, and O3 by obtaining a spectrum about relations between the engine RPM and the frequency as illustrated in FIG. 5, and analyzing the obtained spectrum.

When the at least one of the order components O1, O2, and O3 is detected, the region detector 32 may detect the reinforcement region from the at least one of the order components O1, O2, and O3 in accordance with settings predefined by the user or designer. For example, the region detector 32 may determine a region with a relatively low intensity O12, O22, or O32 or a region with a relatively high intensity O11, O21, or O13, as the reinforcement region, from the at least one of the order components O1, O2, and O3. Also, the region detector 32 may determine a region between the region with a relatively low intensity O12, O22, or O32 and the region with a relatively high intensity O11, O21, or O13, as the reinforcement region.

In one form, the region detector 32 may determine only one region O11 or O12 of one of the plurality of order components O1, O2, and O3, e.g., the C2 component, as the reinforcement region, or may determine some regions O11, O12, O21, and O22 of the plurality of order components O1, O2, and O3, e.g., the C2 order component O1 and the C4 order component O2, as the reinforcement regions.

When the reinforcement regions are detected from the plurality of order components O1 and O2, the region detector 32 may determine the reinforcement regions by applying the same standard to each of the order components O1 and O2 or by applying different standards to the order components O1 and O2. For example, the region detector 32 may determine regions with relatively low intensities O12 and O22 as the reinforcement regions from both the C2 order component O1 and the C4 order component O2. In another form, the region with a relatively low intensity O12 may be determined as the reinforcement region from the C2 order component O1, and the region with relatively high intensity O21 may be determined as the reinforcement region from the C4 order component O2.

The region detector 32 may also detect the reinforcement regions O11, O12, O21, O22, O31, and O32 from all of the order components O1, O2, and O3. In this case, the reinforcement regions may be determined from all of the order components O1, O2, and O3 by using the same or different standards as described above.

Besides, the region detector 32 may determine the reinforcement region from each of the order components O1, O2, and O3 using various methods selected by the user and/or the designer.

The reinforcing signal generator 33 may generate a reinforcing signal in accordance with the reinforcement region detected by the region detector 32. For example, if the region detector 32 determines the region with a relatively low intensity O12 of the C2 order component O1 as the reinforcement region, the reinforcing signal generator 33 may generate a reinforcing signal corresponding to the reinforcing sound E2 such that the reinforcing sound E2 output from the reinforcing sound output unit 40 reinforces the engine sound E1 having a frequency band corresponding to the reinforcement region O12 of the C2 order component O1. The reinforcing signal generator 33 may generate various reinforcing signals in accordance with the number of reinforcement regions, the range of the reinforcement region, and/or intensity of the engine sound E1 of the reinforcement region in the one of the order components O1, O2, and O3.

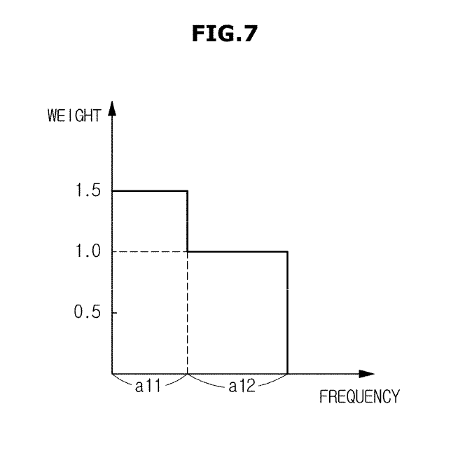

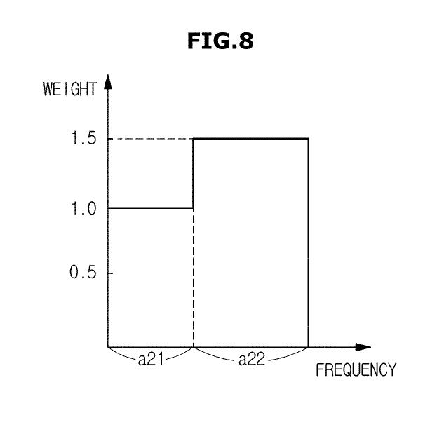

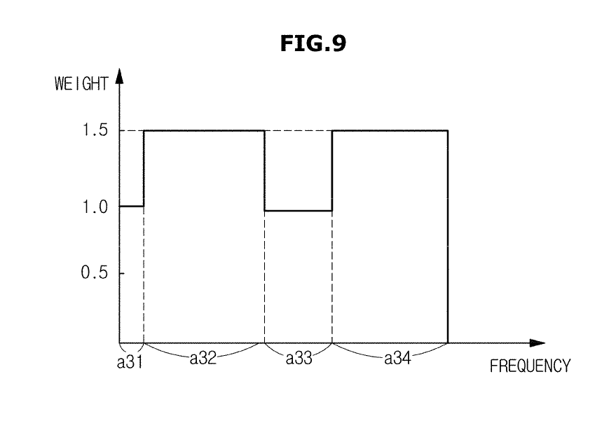

FIG. 7 is a graph illustrating a first example of weights applied to an order component of the engine. FIG. 8 is a graph illustrating a second example of weights applied to an order component of the engine. FIG. 9 is a graph illustrating a third example of weights applied to an order component of the engine.

According to one form, the reinforcing signal generator 33 may use a predetermined weight 37 to generate a reinforcing signal. The weight 37 may be pre-stored in the separate storage unit 35.

Particularly, the reinforcing signal generator 33 may generate an output signal to which the weight 37 is applied, i.e., the reinforcing signal, by applying the weight 37 to an output signal. Here, the output signal refers to an electric signal that is converted into a sound corresponding thereto and output by the reinforcing sound output unit 40.

The reinforcing signal generator 33 may generate the reinforcing signal by applying the weights 37 depending on the reinforcement regions detected by the region detector 32. If the reinforcement regions detected by the region detector 32 are different, the reinforcing signal generator 33 may generate the reinforcing signal by applying different weights 37 to the output signal. Here, the weights 37 may be designed to be different depending on the frequency bands as illustrated in FIGS. 7 to 9.

For example, if the region detector 32 detects the region with a relatively low intensity O12 from the C2 order component O1 of FIG. 6, the reinforcing signal generator 33 may generate a reinforcing signal to reinforce the region with a relatively low intensity O12 by applying the weights 37 to the output signal as illustrated in FIG. 7. When these weights 37 are applied, a relatively high weight, e.g., 1.5, may be applied to a lower frequency band all and a relatively low weight, e.g., 1, may be applied to a high frequency band a12. The reinforcing sound output unit 40 generates and outputs a reinforcing sound E2 corresponding to the generated reinforcing signal, thereby reinforcing the region with a relatively low intensity O12 without reinforcing the region with a relatively high intensity O11 in the C2 order component O1 of the engine sound E1.

As another example, if the region detector 32 detects the region with a relatively high intensity O11 from the C2 order component O1 of FIG. 6, the reinforcing signal generator 33 may generate a reinforcing signal by applying the weights 37, which are designed to apply a relatively low weight, e.g., 1, to the lower frequency band a21 and a relatively high weight, e.g., 1.5, to the high frequency band a22, to the output signal as illustrated in FIG. 8. Thus, the reinforcing sound output unit 40 generates and outputs a reinforcing sound E2 corresponding to the generated reinforcing signal that reinforces the region with a relatively high intensity O11 without reinforcing the region with a relatively low intensity O12 in the C2 order component O1 of the engine sound E1.

As another example, the reinforcing signal generator 33 may generate a reinforcing signal by applying the weights 37, which are determined to apply a relatively low weight to at least one of the frequency bands a31 and a33 and a relatively high weight to at least one of the frequency bands a32 and a34 among a plurality of frequency bands a31 to a34, to the output signal in accordance with a region to be reinforced as illustrated in FIG. 9.

Although, examples of the weights 37 are described above with reference to FIGS. 7 to 9, values and shapes of the weights 37 are not limited thereto. Depending on the designer's selection, the weights 37 may be designed in various shapes in accordance with regions expected to be selected as the reinforcement regions.

For example, although the weights 37 are discretely defined according to frequency bands in FIGS. 7 to 9, the weights 37 may also be continuously defined differently from the drawings. In addition, although the weights 37 are defined as 0.1, or 1.5 according to the frequency bands in FIGS. 7 to 9, the weights 37 may also be defined as various other values. For example, the weights 37 may be defined as various real numbers such as 0.5, 2, or 3 in given frequency bands. In addition, the weight 37 may be defined as 0 in a given frequency band by the designer, if desired.

If each of the order components O1, O2, and O3 is reinforced, the reinforcing signal generator 33 may obtain reinforcing signals respectively for the order components O1, O2, and O3 by using the same weight 37 or different weights 37. In addition, according to one form, the reinforcing signal generator 33 may obtain reinforcing signals for some of the order components O1, O2, and O3 using the same weight 37 and reinforcing signals for the other order components using a different weight 37.

According to another form, the reinforcing signal generator 33 may generate reinforcing signals to reinforce all or some of the order components O1, O2, and O3 in accordance with the driving mode 36 of the vehicle 1. In particular, the reinforcing signal generator 33 may generate different reinforcing signals according to the driving mode 36. In this case, the reinforcing signal generator 33 may generate a reinforcing signal according to the driving mode 36 by generating the reinforcing signal by calling a weight 37 predefined according to the driving mode 36. When the weight 37 predefined according to the driving mode is applied to the order components O1, O2, and O3, different weights 37 or the same weight 37 may be applied to the respective order components O1, O2, and O3. Also, the same weight 37 may be applied to some of the order components O1, O2, and O3, and different weights 37 may be applied to the other order components.

The reinforcing signal generated by the reinforcing signal generator 33 is transmitted to the signal output unit 34. The signal output unit 34 transmits the reinforcing signal to the reinforcing sound output unit 40 via a predetermined communication network, and the reinforcing sound output unit 40 outputs the reinforcing sound E2 corresponding to the reinforcing signal to the outside in response to the received reinforcing signal.

The reinforcing sound E2 output from the reinforcing sound output unit 34 is mixed with the engine sound E1 from the engine 10 and transmitted to the user 9. The user 9 may listen a reinforced engine sound E3 in which a given region is reinforced.

The reinforcing signal generating operation of the controller 30 may be the same as or slightly different from an operation of processing a noise in addition to the engine sound E1 performed by various devices equipped in the vehicle 1. For example, the controller 30 may determine whether a rattle noise generated by a gear is desired to be reinforced, generate a reinforcing signal to reinforce or reduce all or a part of the rattle noise, and transmit the reinforcing signal to the reinforcing sound output unit 34. The reinforcing sound output unit 34 may generate a reinforcing sound to reinforce or reduce all or a part of the rattle noise in response thereto, and output the reinforcing sound.

In addition, the controller 30 may use the same method or a partially modified method to process complex noises of the engine 10 and other devices equipped in the vehicle.

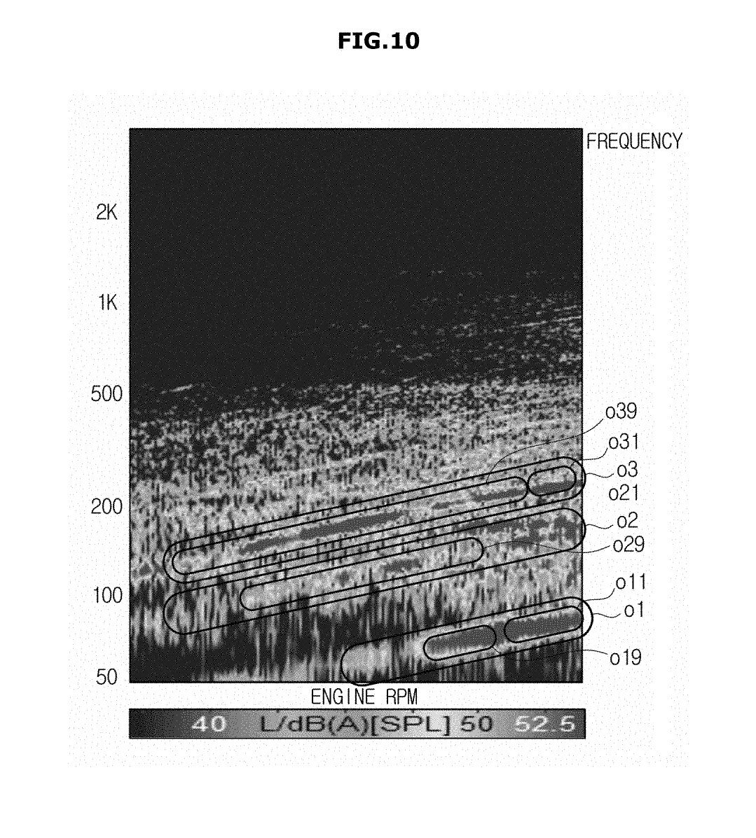

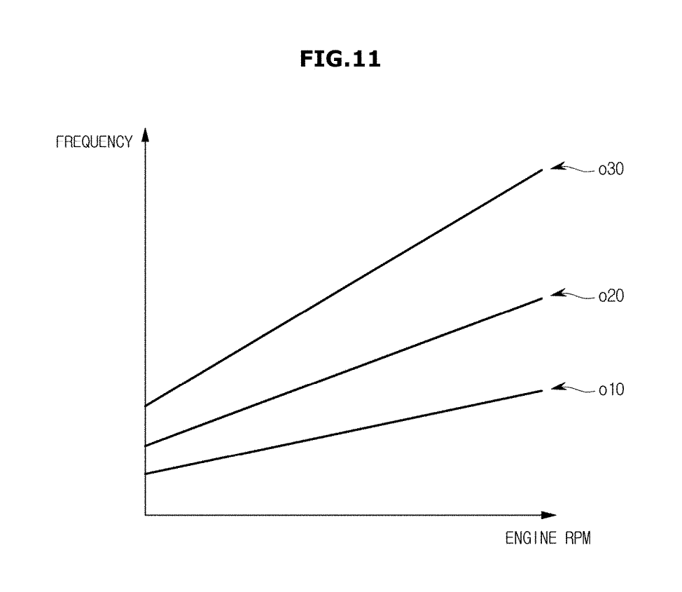

FIG. 10 is a first diagram for describing order components of an engine sound reinforced by the controller. FIG. 11 is a second diagram for describing order components of the engine sound reinforced by the controller.

If the engine sound E1 has a C2 order component O1, a C4 order component O2, and a C6 order component O3 as illustrated in FIGS. 5 and 6, the controller 30 generates reinforcing signals to reinforce regions with relatively low intensities O12, O22, and O32 of the C2 order component O1, the C4 order component O2, and the C6 order component O3, and the reinforcing sound output unit 40 outputs the reinforcing sound E2 corresponding thereto, given regions O19, O29, and O39 of the order components O1, O2, and O3 of the engine sound E1 are reinforced as illustrated in FIG. 10. Thus, the reinforced sound is provided to the user 9. In other words, as illustrated in FIG. 11, a reinforced engine sound E3, in which relatively large regions of order components O10, O20, and O30 are reinforced, is provided to the user 9. Accordingly, the user 9 may listen the reinforced engine sound E3 instead of the engine sound E1 generated in the engine 10. Thus, the user 9 may drive the vehicle 1 with high interest while feeling acceleration as sounds.

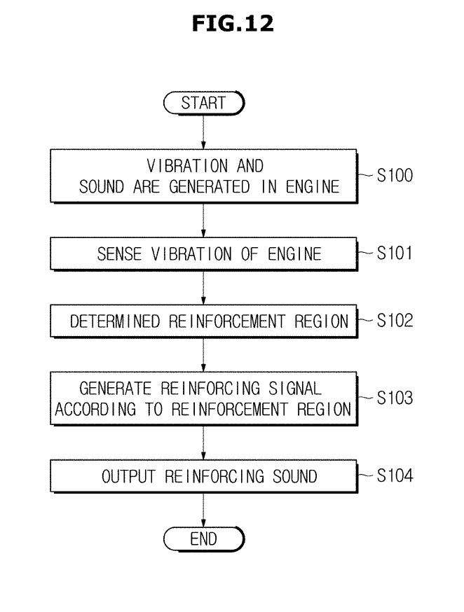

Hereinafter, a method of processing an engine sound and a method of controlling a vehicle will be described with reference to FIG. 12.

FIG. 12 is a flowchart for describing a method of processing an engine sound according to the present disclosure.

Referring to FIG. 12, when the engine installed in the engine room of the vehicle starts to operate, the engine of the vehicle vibrates and an engine sound is generated from the engine (100).

The sensing device senses an operation of the engine, particularly, vibration of the engine, and transmits a sensing result to a controller installed inside or outside the vehicle (101). In this case, the sensing device may be directly mounted on the engine or installed adjacent to the engine.

The controller may determine a region of the engine sound desired to be reinforced, i.e., reinforcement region, by using information about vibration of the engine (102). In this case, the controller may determine a reinforcement region in accordance with a driving mode of the vehicle. In addition, the controller may detect a region to be reinforced in the engine sound from vibration of a pre-defined range of frequency bands. For example, the controller may determine a region to be reinforced in the engine sound by using vibration of a given frequency or less.

In addition, the controller may detect an order component of vibration by performing order analysis on information about vibration of the engine. Since the engine sound may be caused by vibration generated by explosion of a mixed gas of the engine, the order component of vibration corresponds to the order component of the engine sound. Accordingly, the controller may detect the order component of the engine sound. The controller may determine a region to be reinforced in the engine sound among the detected order component. In this case, the controller may determine all or some selected from one or at least two of the order components as reinforcement regions. The reinforcement region may be a region with a relatively low intensity of vibration or a region with a relatively high intensity of vibration among all regions of the order components.

When the reinforcement region is determined, the controller may generate a reinforcing signal corresponding to the reinforcement region (103). According to one form, the controller may generate the reinforcing signal by using a preset weight. Particularly, the controller may generate the reinforcing signal by applying the preset weight to an output signal to obtain an output signal to which the weight is applied. According to another form, the same or different weights may be applied to the order components.

In case of generating the reinforcing signal, the controller may generate different reinforcing signals according to driving modes. The controller may generate the reinforcing signals by applying the same or different weights to the respective order components in accordance with the driving modes.

The reinforcing signal of the controller may be transmitted to the reinforcing sound output unit, and the reinforcing sound output unit may output a reinforcing sound corresponding to the reinforcing signal (104). Accordingly, the user may listen a reinforced engine sound obtained by mixing the engine sound with the reinforcing sound.

According to one form, the reinforcing sound output unit may be implemented using a speaker.

For example, the reinforcing sound output unit may be installed in the engine room of the vehicle or at the bulkhead, which separates the engine room from the indoor space of the vehicle, to output sounds toward the indoor space. As another example, the reinforcing sound output unit may also be installed in the indoor space of the vehicle. In this case, the reinforcing sound output unit may be implemented using a navigation device or a speaker equipped in the vehicle.

The method of processing the engine sound may also be applied to the method of controlling the vehicle in the same manner or in a modified manner.

The method of processing the engine sound and the method of controlling the vehicle according to the aforementioned forms may be realized with programs driven in various computer devices. Here, the programs may include program commands, data files, and data structures alone or in combination. For example, the programs may be designed or constructed using machine codes created by a compiler and high-level language codes executable by a computer using an interpreter. The programs may be specifically designed for exemplary forms to realize the method of processing the engine sound and the method of controlling the vehicle or implemented using various functions or definitions well-known to those skilled in computer software.

The programs to realize the method of processing the engine sound and the method of controlling the vehicle may be recorded in a computer-readable recording medium. The computer-readable recording medium includes magnetic disc storage media such as hard disk and floppy disk, magnetic tapes, optical media such as CDs and DVDs, magneto-optical media such as floptical disk, and hardware devices containing and executing program commands, such as ROM, RAM, and flash memory.

Although the apparatus and method of processing a sound from an engine or the vehicle, and the method of controlling the vehicle are described herein, they are not limited to the forms described above. Various other forms modified and changed by those of ordinary skill in the art based on the aforementioned forms may also be applied to the apparatus and method of processing a sound from an engine and the vehicle, and the method of controlling the vehicle. For example, even when the order of descriptions is changed, or the constituent elements such as systems, structures, devices, circuits, and the like are assembled or combined in a different manner from those described above and/or replaced or substituted by other constituent elements or equivalents, results, which are the same as or similar to those of the apparatus and method of processing a sound from an engine, the vehicle, and the method of controlling the vehicle described above, may be obtained.

As is apparent from the above description, according to the apparatus and method of processing a sound from an engine, the vehicle, and the method of controlling the vehicle, a desired engine sound may be obtained by appropriately tuning the sound generated in the engine.

According to the apparatus and method of processing a sound from an engine, the vehicle, and the method of controlling the vehicle, the driver of the vehicle and/or the passenger may be provided with various desired types of engine sounds.

According to the apparatus and method of processing a sound from an engine, the vehicle, and the method of controlling the vehicle, the driver and/or the passenger may be provided with engine sounds more suitable and appropriate for driving operation of the vehicle compared with engine sounds reproduced by the multimedia device installed inside the vehicle by tuning sounds from the engine in real time in accordance with operation of the engine.

According to the apparatus and method of processing a sound from an engine, the vehicle, and the method of controlling the vehicle, the driver and/or the passenger may be provided with processed engine sounds such that the driver and/or the passenger recognize those as intrinsic sounds from the engine room instead of artificial engine sounds reproduced by the multimedia device installed inside the vehicle.

According to the apparatus and method of processing a sound from an engine, the vehicle, and the method of controlling the vehicle, undesired noises generated by the powertrain may be blocked.

Although a few forms of the present disclosure have been shown and described, it would be appreciated by those skilled in the art that changes may be made in these forms without departing from the principles and spirit of the disclosure.

1. An apparatus for processing a sound from an engine comprising:
an engine configured to generate an engine sound;
a sensing device configured to sense vibration of the engine;
a controller configured to identify a region of the engine sound to be reinforced based on the vibration of the engine and to generate a reinforcing signal to reinforce the engine sound at the identified region; and
an output unit configured to output a reinforcing sound corresponding to the reinforcing signal.

2. The apparatus according to claim 1, wherein the output unit is installed in a space in which the engine is installed.

3. The apparatus according to claim 1, wherein the controller is configured to generate the reinforcing signal in a predefined frequency band.

4. The apparatus according to claim 1, wherein the controller is configured to generate the reinforcing signal to reinforce all regions or a partial region of at least one order component among a plurality of order components of the engine.

5. The apparatus according to claim 4, wherein the controller is configured to generate the reinforcing signal to reinforce a region with a relatively high intensity or a region with a relatively low intensity among all regions of the order component.

6. The apparatus according to claim 4, wherein the controller is configured to generate the reinforcing signal to reinforce all regions or a partial region of at least one order component by using preset weights.

7. The apparatus according to claim 6, wherein the preset weights are different based on the at least one order component.

8. The apparatus according to claim 4, wherein the controller is configured to generate different reinforcing signals to reinforce all regions or a partial region of the at least one order component among the plurality of order components of the engine in accordance with a driving mode of a vehicle.

9. The apparatus according to claim 1, wherein the controller is configured to generate the reinforcing signal in real time.

10. A vehicle comprising:
an engine room separated from an indoor space of the vehicle;
an engine installed in the engine room;
a sensing device installed in contact with or adjacent to the engine and configured to sense vibration of the engine;
a controller configured to identify a region of an engine sound to be reinforced based on the vibration of the engine and configured to generate a reinforcing signal to reinforce the engine sound at the identified region; and
an output unit installed in the engine room and configured to generate a reinforcing sound based on the reinforcing signal and output the reinforcing sound toward the indoor space.

11. A method of processing a sound from an engine, the method comprising:
sensing, by a sensor, a vibration of an engine;
identifying, by a controller, a region of an engine sound to be reinforced based on the vibration of the engine;
generating, by the controller, a reinforcing signal to reinforce the engine sound at the identified region; and
outputting, by an output unit, a reinforcing sound corresponding to the reinforcing signal.

12. The method according to claim 11, wherein the output unit is installed in a same space as a space in which the engine is installed.

13. The method according to claim 11, wherein the generating of the reinforcing signal comprises generating the reinforcing signal in a predefined frequency band.

14. The method according to claim 11, wherein the generating of the reinforcing signal comprises generating a reinforcing signal to reinforce all regions or a partial region of at least one order component among a plurality of order components of the engine.

15. The method according to claim 14, wherein the generating of the reinforcing signal to reinforce all regions or a partial region of the at least one order component among the plurality of the order components of the engine comprises generating a reinforcing signal to reinforce a region with a relatively high intensity or a region with a relatively low intensity among all regions of the at least one order component.

16. The method according to claim 14, wherein the generating of the reinforcing signal to reinforce all regions or a partial region of the at least one order component among the plurality of the order components of the engine comprises generating a reinforcing signal to reinforce all regions or a partial region of the at least one order component by using preset weights.

17. The method according to claim 16, wherein the weights are different based on the at least one order component.

18. The method according to claim 14, wherein the generating of the reinforcing signal to reinforce all regions or a partial region of the at least one order component among the plurality of the order components of the engine comprises generating different reinforcing signals to reinforce all regions or a partial region of the at least one order component among the plurality of the order components of the engine in accordance with a driving mode of the vehicle.

19. The method according to claim 11, wherein the generating of the reinforcing signal is performed in real time.

20. A method of controlling a vehicle, the method comprising:
sensing, by a sensor, a vibration of an engine installed in an engine room separated from an indoor space of the vehicle;
identifying, by a controller, a region of an engine sound to be reinforced based on the vibration of the engine;
generating, by the controller, a reinforcing signal to reinforce the engine sound at the identified region;
generating a reinforcing sound based on the reinforcing signal; and
outputting, by an output unit installed in the engine room, the reinforcing sound toward the indoor space.
